(19) United States
(12) Patent Application Publication
(10) Pub. No.: US 2007/0115470 A1
(43) Pub. Date: May 24, 2007

(54) Automated laser-assisted positioning method and system for a display production line

(75) Inventor: Makoto Huang, Kaohsiung City (TW)

Correspondence Address: SCHWEGMAN, LUNDBERG, WOESSNER & KLUTH, P.A., P.O. BOX 2938, MINNEAPOLIS, MN, 55402, US

(73) Assignee: Hannspree, Inc.

(21) Appl. No.: 11/322,461

(22) Filed: Dec. 30, 2005

(30) Foreign Application Priority Data
Nov. 23, 2005 (TW) 94141174

(51) Int. Cl. G01B 11/00

(52) U.S. Cl. 356/400

(57) ABSTRACT

An automated laser-assisted display positioning system includes a data storage medium for storing a database that contains a plurality of sets of coordinate data, each of which corresponds to outer configuration of a respective distinct display device model. A control module is coupled to the data storage medium, and is operable to retrieve one of the sets of coordinate data from the database with reference to an input condition. A light source module includes a first laser light source for forming a first reference line on a station of a display production line, and a second laser light source for forming a second reference line on the station. The light source module is controlled by the control module such that the first and second reference lines have spatial positions on the station that correspond to the retrieved set of coordinate data.

### CROSS-REFERENCE TO RELATED APPLICATION

This application claims priority of Taiwanese application no. 094141174, filed on Nov. 23, 2005.

### BACKGROUND OF THE INVENTION

1. Field of the Invention

The invention relates to the production of display devices, more particularly to an automated laser-assisted positioning method and system for a display production line.

2. Description of the Related Art

Referring to FIG. 1, a display device 11, such as a liquid crystal display device, is disposed on a calibration station 10 of a display production line such that the display device 11 is spaced apart from a lens (not shown) by a predetermined distance and orientation so as to proceed with white balance adjustment prior to delivery. For display devices 11 that have rectangular outer configurations, positioning of the same on the calibration station 10 can be conducted with relative ease with the use of a fixed-length ruler 12 on the calibration station 10.

However, to attract consumers' attention, the outer configurations of some display devices have been re-designed from standard rectangular configurations to other contours, such as those that resemble cartoon characters, animals, logos of sports franchises, etc. The edges of such display devices may have a slope, a curve or be hemi-spherical, etc. For such irregularly shaped display devices, the conventional process of positioning on the calibration station (i.e., the display device is in an upright state and is positioned on the calibration station with the use of the ruler 12) may no longer be applicable, thereby resulting in difficulty during white balance adjustment. In addition, since these irregularly shaped display devices are fabricated in limited numbers, it is not economically feasible for manufacturers to design a specific positioning system for each distinct display device model. As a result, positioning of such irregularly shaped display devices on a calibration station is currently conducted manually, and lots of time and effort are consumed during white balance adjustment.

### SUMMARY OF THE INVENTION

Therefore, the objective of the present invention is to provide an automated laser-assisted positioning method and system for a display production line that can overcome the above drawbacks associated with the prior art.

According to one aspect of the present invention, there is provided an automated laser-assisted positioning method for providing assistance in positioning a display device on a station of a display production line. The automated laser-assisted positioning method comprises the steps of:

a) establishing a database that contains a plurality of sets of coordinate data, each of which corresponds to outer configuration of a respective distinct display device model;

b) retrieving one of the sets of coordinate data from the database with reference to an input condition; and

c) controlling a plurality of laser light sources to form at least one first reference line and at least one second reference line on the station such that the first and second reference lines have spatial positions on the station that correspond to one of the sets of coordinate data retrieved in step b).

According to another aspect of the present invention, there is provided an automated laser-assisted positioning system adapted for providing assistance in positioning a display device on a station of a display production line. The automated laser-assisted positioning system comprises a data storage medium, a control module, and a light source module. The data storage medium stores a database that contains a plurality of sets of coordinate data, each of which corresponds to outer configuration of a respective distinct display device model. The control module is coupled to the data storage medium, and is operable so as to retrieve one of the sets of coordinate data from the database with reference to an input condition. The light source module is coupled to the control module, and includes at least one first laser light source for forming a first reference line on the station, and at least one second laser light source for forming a second reference line on the station. The light source module is controlled by the control module such that the first and the second reference lines have spatial positions on the station that correspond to one of the sets of coordinate data retrieved from the database by the control module.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view to illustrate how a display device is positioned on a calibration station of a display production line in the prior art;

FIG. 2 is a schematic view to illustrate the preferred embodiment of an automated laser-assisted positioning system for providing assistance in positioning a display device on a station of a display production line according to the present invention;

FIG. 3 is a system block diagram of the preferred embodiment;

FIG. 4 is a schematic view to illustrate the first and the second reference lines formed by a light source module of the system on the station of the display production line; and

FIG. 5 is a flowchart to illustrate consecutive steps of the preferred embodiment of an automated laser-assisted positioning method according to the present invention.

### DETAILED DESCRIPTION OF THE PREFERRED EMBODIMENT

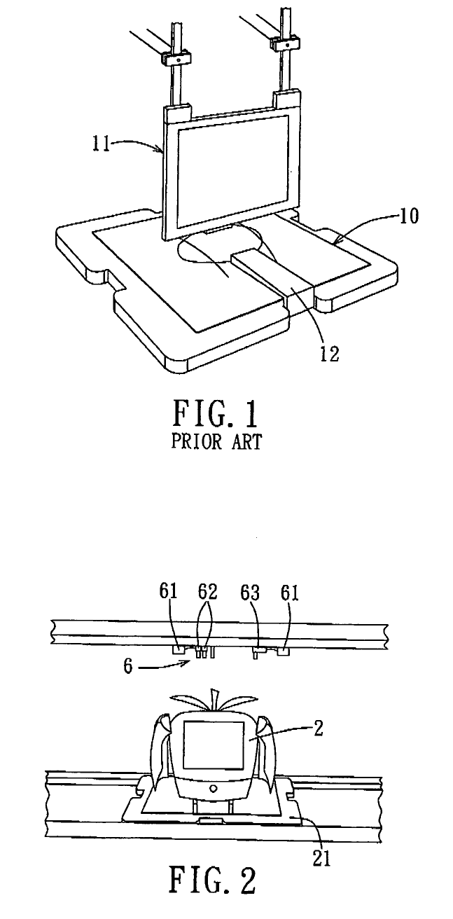

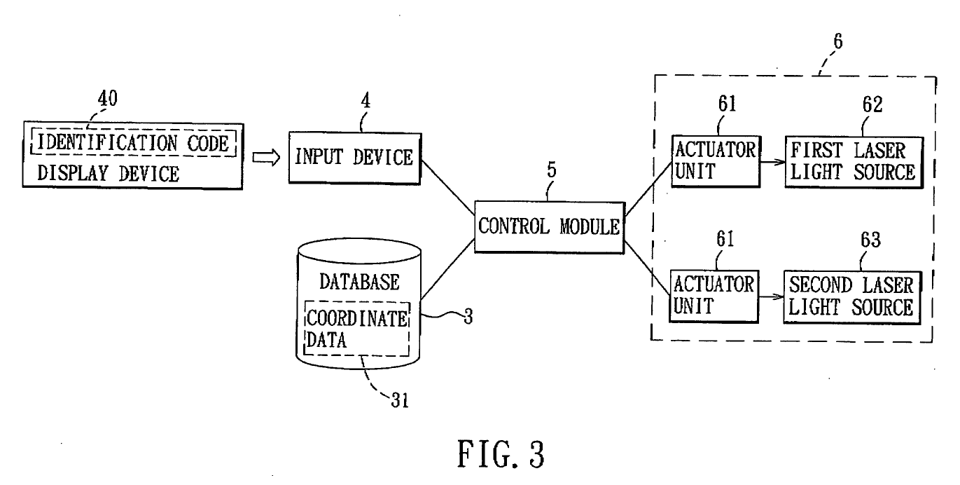

Referring to FIG. 2, the preferred embodiment of an automated laser-assisted positioning system according to the present invention is shown to be adapted for providing assistance in positioning a display device 2, such as liquid crystal display television (LCD-TV), on a calibration station 21 of a display production line. Referring to FIG. 3, the automated laser-assisted positioning system comprises a data storage medium 3, an input device 4, a control module 5, and a light source module 6.

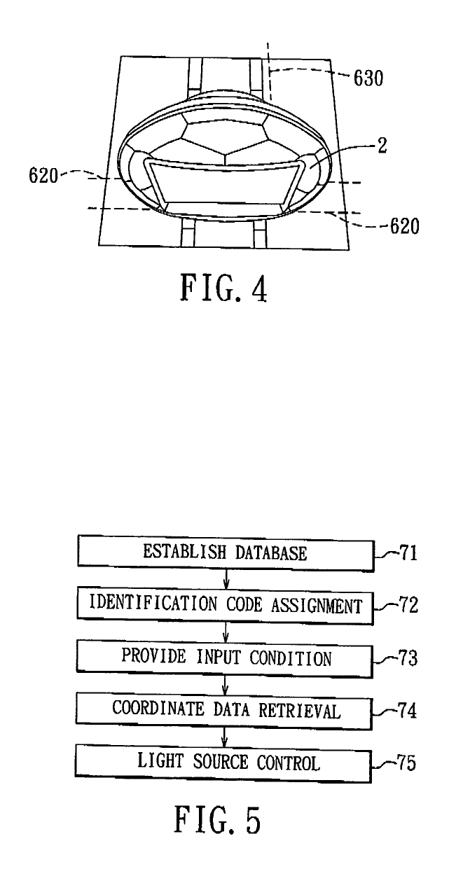

The data storage medium 3 stores a database that contains a plurality of sets of coordinate data 31. Each of the sets of coordinate data 31 corresponds to outer configuration of a respective distinct display device model. Preferably, each of the sets of coordinate data 31 corresponds to at least one of shape, dimensions, and slope of a housing of the respective distinct display device model. For instance, since the display device 2 shown in FIG. 4 has a spherical housing, edges of a front frame and a rear casing of the housing serve as references for positioning in a first direction, whereas either of lateral edges of the housing or a central axis normal to an imaging plane of the display device 2 serve as references for positioning in a second direction orthogonal to the first direction. Position parameters of a properly positioned reference display device 2 on the calibration station 21 are then inputted into the database of the data storage medium 3 to serve as the set of coordinate data 31 for the associated distinct display device model. Preferably, each distinct display device model is assigned a corresponding identification code 40, such as a barcode attached to the housing of the display device 2, and the sets of coordinate data 31 in the database of the data storage medium 3 are indexed according to the identification codes 40 of the distinct display device models.

The input device 4 is coupled to the control module 5 for providing an input condition thereto. In this embodiment, the input device 4 includes a barcode reader adapted to read the identification code 40 on the display device 2 that is to be disposed on the calibration station 21 of the display production line such that the identification code 40 serves as the input condition. It is noted that provision of the input condition to the control module 5 should not be limited to the use of the barcode reader. In other embodiments, the input condition can be provided to the control module 5 through a keypad or menu item selection.

The control module 5 is further coupled to the data storage medium 3, and is operable so as to retrieve one of the sets of coordinate data 31 from the database of the data storage medium 3 with reference to the input condition from the input device 4.

As shown in FIGS. 2 to 4, in this embodiment, the light source module 6 is mounted above the calibration station 21, and includes a plurality of actuator units 61 coupled to the control module 5, and a pair of first laser light sources 62 and a second laser light source 63 controlled by the actuator units 61. In this embodiment, there are two actuator units 61, each of which includes a servo motor unit and each of which is coupled to a respective one of the first and the second laser light sources 62, 63. The first laser light sources 62 form a parallel pair of the first reference lines 620 on the calibration station 21 of the display production line. The second laser light source 63 forms a second reference line 630 on the calibration station 21. The actuator units 61 are controlled by the control module 5 so as to adjust at least one of angular orientation and spatial position of the first and the second laser light sources 62, 63 relative to the calibration station 21 with reference to the set of coordinate data 31 retrieved from the database by the control module 5 such that the first and second reference lines 620, 630 have spatial positions on the calibration station 21 that correspond to the set of coordinate data 31 retrieved from the database by the control module 5. In this embodiment, the first reference lines 620 formed by the first laser light sources 62 extend in a first direction parallel to the imaging plane of the display device 2 that is to be disposed on the calibration station 21. The second reference line 630 formed by the second laser light source 63 extends in a second direction orthogonal to the first direction and normal to the imaging plane of the display device 2 that is to be disposed on the calibration station 21. Therefore, when the display device 2 is disposed on the calibration station 21, front and rear edges as well as tilt of the display device 2 can be adjusted with reference to the first reference lines 620 that are formed by the first laser light sources 62. In addition, either of left and right lateral edges of the display housing or a central axis normal to the imaging plane of the display device 2 can be adjusted with reference to the second reference line 630 formed by the second laser light source 63.

It should be noted herein that the actual numbers of the first and second laser light sources 62, 63 and the first and second reference lines 620, 630 formed thereby are not limited to those disclosed herein. For example, if the outer configuration of the display device 2 has a fixed angular orientation, one first laser light source 62 may be sufficient for forming a single reference line 620 to serve as a reference when adjusting a front or rear edge of the display device 2 on the calibration station 21. Moreover, the number of the second laser light source 63 may be increased depending on actual requirements.

FIG. 5 is a flowchart to illustrate consecutive steps of the preferred embodiment of the automated laser-assisted positioning method according to the present invention. Initially, a database that contains a plurality of sets of coordinate data 31 is established in the data storage medium 3 in step 71. Each of the sets of coordinate data 31 corresponds to outer configuration of a respective distinct display device model. Thereafter, in step 72, an identification code 40 is assigned to a display device 2 (e.g., by attaching a barcode to the display device 2) to associate the same with one of the sets of coordinate data 31 in the data base. Next, in step 73, the identification code 40 on the display device 2 that is to be positioned on the calibration station 21 is read with the use of the input device 4 (e.g., the barcode reader) so as to result in the input condition that is subsequently provided to the control module 5. Then, in step 74, the control module 5 retrieves one of the sets of coordinate data 31 from the database with reference to the input condition from the input device 4. Subsequently, in step 75, the control module 5 generates drive signals for controlling the actuator units 61 to adjust the first and second laser light sources 62, 63 so that the first and second reference lines 620, 630 formed by the first and second laser light sources 62, 63 have spatial positions on the calibration station 21 that correspond to the set of coordinate data 31 retrieved by the control module 5 in step 74. The display device 2 can then be positioned correctly on the calibration station 21 with assistance from the first and second reference lines 620, 630 thus formed.

In sum, the automated laser-assisted positioning method and system according to this invention can be relied upon to effectively position different sizes and shapes of display devices on a calibration station of a display production line through automated generation of visible reference lines on the calibration station. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An automated laser-assisted positioning method for providing assistance in positioning a display device on a station of a display production line, said automated laser-assisted positioning method comprising the steps of:
a) establishing a database that contains a plurality of sets of coordinate data, each of the sets of coordinate data corresponding to outer configuration of a respective distinct display device model;
b) retrieving one of the sets of coordinate data from the database with reference to an input condition; and
c) controlling a plurality of laser light sources to form at least one first reference line and at least one second reference line on the station such that the first and second reference lines have spatial positions on the station that correspond to said one of the sets of coordinate data retrieved in step b).

2. The automated laser-assisted positioning method as claimed in claim 1, wherein, in step a), each of the sets of coordinate data corresponds to at least one of shape, dimensions, and slope of a housing of the respective distinct display device model.

3. The automated laser-assisted positioning method as claimed in claim 1, wherein, in step b), the input condition is an identification code on a display device that is to be disposed on the station of the display production line.

4. The automated laser-assisted positioning method as claimed in claim 3, further comprising the step, prior to step b), of reading the identification code on the display device.

5. The automated laser-assisted positioning method as claimed in claim 1, wherein step c) includes:
c1) controlling a plurality of actuator units to adjust at least one of angular orientation and spatial position of the laser light sources relative to the station with reference to said one of the sets of coordinate data retrieved in step b); and
c2) activating the laser light sources to form the first and second reference lines on the station.

6. The automated laser-assisted positioning method as claimed in claim 1, wherein, in step c), the first reference line extends in a first direction, and the second reference line extends in a second direction orthogonal to the first direction and normal to an imaging plane of a display device that is to be disposed on the station of the display production line.

7. The automated laser-assisted positioning method as claimed in claim 6, wherein, in step c), the laser light sources form a parallel pair of the first reference lines on the station of the display production line.

8. An automated laser-assisted positioning system adapted for providing assistance in positioning a display device on a station of a display production line, said automated laser-assisted positioning system comprising:
a data storage medium for storing a database that contains a plurality of sets of coordinate data, each of the sets of coordinate data corresponding to outer configuration of a respective distinct display device model;
a control module coupled to said data storage medium and operable so as to retrieve one of the sets of coordinate data from said database with reference to an input condition; and
a light source module coupled to said control module, said light source module including at least one first laser light source for forming a first reference line on the station, and at least one second laser light source for forming a second reference line on the station, said light source module being controlled by said control module such that the first and second reference lines have spatial positions on the station that correspond to said one of the sets of coordinate data retrieved from said database by said control module.

9. The automated laser-assisted positioning system as claimed in claim 8, wherein each of the sets of coordinate data contained in said database corresponds to at least one of shape, dimensions, and slope of a housing of the respective distinct display device model.

10. The automated laser-assisted positioning system as claimed in claim 8, further comprising an input device coupled to said control module for providing the input condition thereto.

11. The automated laser-assisted positioning system as claimed in claim 10, the input condition being an identification code on a display device, wherein said input device is adapted to read the identification code on the display device that is to be disposed on the station of the display production line.

12. The automated laser-assisted positioning system as claimed in claim 11, wherein said input device includes a barcode reader.

13. The automated laser-assisted positioning system as claimed in claim 8, wherein said light source module further includes at least two actuator units coupled respectively to said first and second laser light sources and controlled by said control module to adjust at least one of angular orientation and spatial position of said first and second laser light sources relative to the station with reference to said one of the sets of coordinate data retrieved from said database by said control module.

14. The automated laser-assisted positioning system as claimed in claim 13, wherein each of said actuator units includes a servo motor unit.

15. The automated laser-assisted positioning system as claimed in claim 8, wherein the first reference line formed by said first laser light source extends in a first direction, and the second reference line formed by said second laser light source extends in a second direction orthogonal to the first direction and normal to an imaging plane of a display device that is to be disposed on the station of the display production line.

16. The automated laser-assisted positioning system as claimed in claim 15, wherein said light source module includes a pair of said first laser light sources for forming a parallel pair of the first reference lines on the station of the display production line.
